(19) United States
(12) Patent Application Publication
(10) Pub. No.: US 2003/0076332 A1
(43) Pub. Date: Apr. 24, 2003

(54) Apparatus and method for eliminating afterimage state

(75) Inventor: Hyon-shik Choi, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/140,052

(22) Filed: May 8, 2002

(30) Foreign Application Priority Data
Oct. 18, 2001 (KR) 2001-64386

(51) Int. Cl. G09G 5/00

(52) U.S. Cl. 345/581

(57) ABSTRACT

An apparatus and a method for eliminating an afterimage while displaying the same image continuously are provided. The afterimage elimination apparatus includes: a display unit for displaying an input image signal; and a controller for moving a display position of the image based on pre-determined movement range information if the controller judges that the image displayed on the display unit continues to be displayed for a certain period of time. The movement range information is within the values that do not allow a user to recognize the movement of the image visibly, and includes a movement direction and a movement amount. Therefore, even though the same image is displayed on a display panel for a certain period of time, an afterimage can be prevented.

### BACKGROUND OF THE INVENTION

1. Field of the Invention

The present invention relates to a display device and a display method, and more particularly, to an apparatus and a method for eliminating an afterimage generated in a display panel. The present application is based on Korean Patent Application No. 2001-64386, filed Oct. 18, 2001, which is incorporated herein by reference.

2. Description of the Related Art

An afterimage is generated when the same image is displayed for a certain period of time. An afterimage may be especially clear when the display device is a Liquid Crystal Display (LCD) panel.

In the past, if the same image is displayed for a certain period of time, a pre-configured OSD image is displayed instead of the image or the display device is set up in a standby mode in order to eliminate the afterimage. However, when the afterimage is eliminated by the above methods, the user cannot view the image at the time that the afterimage is expected to happen.

### SUMMARY OF THE INVENTION

To solve the above-described problem, it is an object of the present invention to provide an apparatus and a method for eliminating an afterimage while displaying the same image continuously.

To achieve the above object, an apparatus for eliminating the afterimage according to an embodiment of the present invention includes:

a display unit for displaying an input image signal; and

a controller for moving a display position of the image based on predetermined movement range information if the controller judges that the image displayed on the display unit continues to be displayed for a certain period of time.

The movement range information is within the values that do not allow a user to recognize the movement of the image visibly, and includes a movement direction and a movement amount.

To achieve the above object, an afterimage elimination apparatus according to an embodiment of the present invention includes:

a memory for storing an input image signal;

a comparator for comparing frame image signals using data read from the memory and/or data written into the memory;

a display unit for displaying the image signal;

an operation unit for operating the display unit so that the image signal can be displayed on the display unit; and

a controller for controlling the operation unit so that the display position of the image can be moved based on pre-determined movement range information when the controller judges that the image displayed on the display unit continues to be displayed for a certain period of time after the comparison of the comparator.

To achieve the above object, a method for eliminating an afterimage from a display device, the afterimage elimination method includes:

setting up a movement range of an image and a time to determine the movement of the image displayed on the display device if an afterimage elimination mode is set up; and

moving the image based on the information of the movement range if the image displayed on the display device continues to be displayed for a certain period of time.

It is preferable that moving the image includes:

a first movement step of moving the image in the left direction by a pre-determined number of pixels if it is judged that the image continues to be displayed for a certain period of time after frame image signals are compared;

a second movement step of moving the image in the upper direction by the pre-determined number of pixels if it is judged that the image continues to be displayed for the certain period of time after the first movement step;

a third movement step of moving the image in the right direction by the pre-determined number of pixels if it is judged that the image continues to be displayed for the certain period of time after the second movement step; and

a fourth movement step of moving the image in the lower direction by the pre-determined number of pixels if it is judged that the image continues to be displayed for the certain period of time after the third movement step.

### BRIEF DESCRIPTION OF THE DRAWINGS

The above object and advantages of the present invention will become more apparent by describing in detail preferred embodiments thereof with reference to the attached drawings in which:

FIG. 1 is a block diagram of an apparatus for eliminating an afterimage according to a preferred embodiment of the present invention; and

FIG. 2 is a flowchart showing a method to eliminate the afterimage according to the preferred embodiment of the present invention.

### DETAILED DESCRIPTION OF THE INVENTION

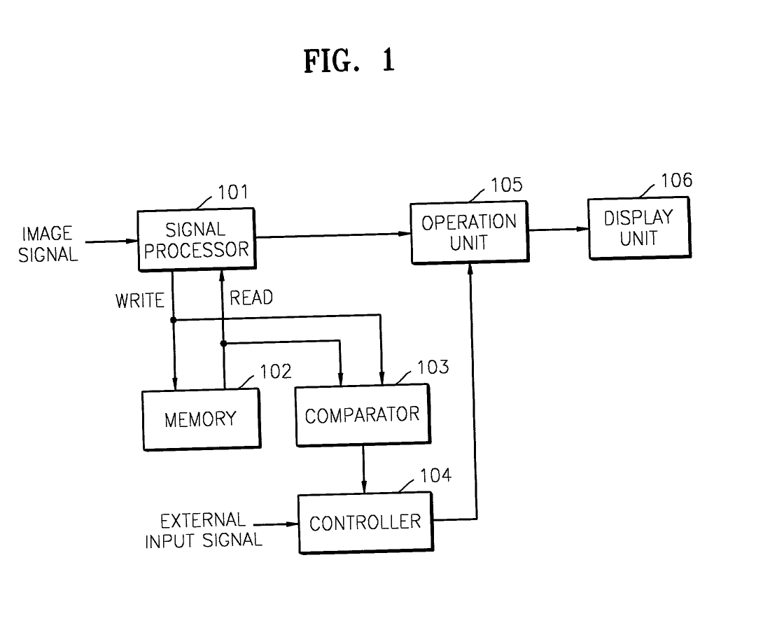

FIG. 1 is a block diagram of an apparatus for eliminating an afterimage according to a preferred embodiment of the present invention. With reference to FIG. 1, the afterimage eliminating apparatus according to the present invention includes a signal processor 101, a memory 102, a comparator 103, a controller 104, an operation unit 105 and a display unit 106.

The signal processor 101 converts an input image signal into a display format. If the signal processor 101 receives the image signal, it writes the signal into the memory 102, and reads an image signal stored in the memory 102 and converts the read signal into the display format and outputs it.

The format conversion processing in the signal processor 101 is performed in a known way. For example, if a display device is a CRT display apparatus, the signal processor 101 converts the image signal inputted from the memory 102 into the format that can be displayed on the CRT. If the display device is an LCD television, the signal processor 101 converts the image signal inputted from the memory 102 into the format that can be displayed on the LCD.

The memory 102 stores image data by a frame unit.

The comparator 103 compares the image signal written into the memory 102 with the image signal read from the memory 102. That is, with a pre-determined time gap, the comparator 103 compares image signals written into the memory 102, and read from the memory 102 in order to identify if any change exists in the image signals by a frame unit. That is, the comparator 103 identifies if there is any difference between a previous frame image and a current frame image, or between the current frame image and the next frame image. Therefore, the pre-determined time gap is set to compare the image signals by the frame unit.

However, if there is one frame difference between the image signal read from the memory 102 by the signal processor and the image signal written into the memory 102, the comparator 103 compares the image written into the memory 102 with that read from the memory 102. Then, the comparator 103 can identify if there is any difference between frames and display the identification result.

As for the controller 104, an afterimage elimination mode is set up by an external input signal. In the afterimage elimination mode, the controller 104 sets up operation conditions necessary to eliminate the afterimage if information of various conditions is inputted from the exterior. According to the present invention, the position of the displayed image may be moved in order to eliminate the afterimage. Therefore, the operation conditions include the time during which the displayed image continues to be displayed and a movement range including the movement direction and the movement amount of the image.

Then, the controller 104 judges whether the same image is displayed for a certain period of time, based on the comparison result transmitted by the comparator 103. If the controller 104 judges that the same image is displayed for a certain period of time, it sends a control signal, according to which the position of the displayed image is moved based on the condition information about the movement range, to the operation unit 105.

For example, the condition information on the movement range specifies that the image needs to be moved in left, upper, right and lower directions in that order by one pixel. Then, if the controller 104 judges that the same image continues to be displayed for a certain period of time, it sends the control signal, which causes the displayed image to move by one pixel in the left direction, to the operation unit 105.

After the image is moved in the left direction by one pixel, if the controller 104 judges that the same image continues to be displayed for a certain period of time, the controller 104 sends the control signal, which causes the displayed image to move by one pixel in the upper direction, to the operation unit 105.

After the image is moved in the upper direction by one pixel, if the controller 104 judges that the same image continues to be displayed for a certain period of time, the controller 104 sends the control signal, which causes the displayed image to move by one pixel in the right direction, to the operation unit 105.

After the image is moved in the right direction by one pixel, if the controller 104 judges that the same image continues to be displayed for a certain period of time, the controller 104 sends the control signal, which causes the displayed image to move by one pixel in the lower direction, to the operation unit 105.

The controller 104 repeats the above operation until it judges that the same image does not continue to be displayed for a certain period of time. In addition, the control signal may be a signal designed to move the start position of the image by one pixel. The movement order of the image is set as left, upper, right and lower directions, but the order may be changed. The pixel movement can be changed from a value of one pixel to another value to the extent that the user cannot visually detect the movement of the image.

The operation unit 105 operates the display unit 106 so that the image signal transmitted from the signal processor 101 can be displayed on a desired position of the display unit 106 according to the control signal transmitted by the controller 104. To display the image signal transmitted by the signal processor 101 on the display unit 106, the operation unit 105 operates the display unit 106 in the same way as an existing display device does.

The display unit 106 can be a CRT or an LCD display unit.

The signal inputted from the exterior is the signal that is input by the user who uses a remote controller or a similar key entry unit (not shown).

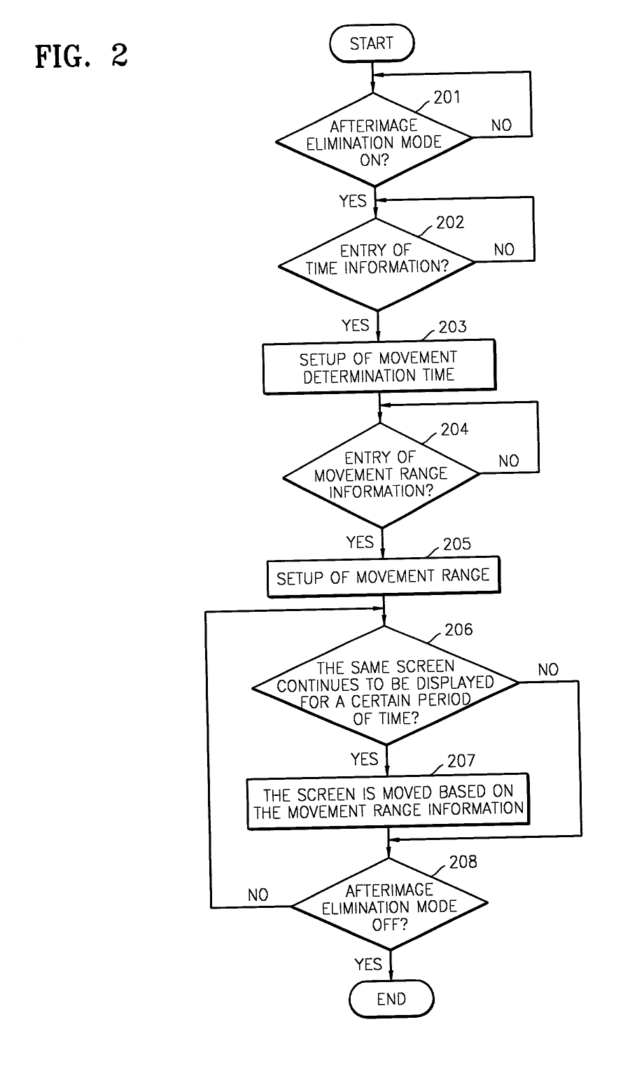

FIG. 2 is a flowchart showing a method to eliminate the afterimage according to the preferred embodiment of the present invention. With reference to FIG. 2, the method to eliminate the afterimage is described below.

In step 201, if the controller 104 judges that a signal that requests turning ON of the afterimage elimination mode is entered, it judges whether information of operation conditions that are necessary to eliminate the afterimage is entered and whether the operation conditions are set up in steps 202 through 205.

That is, the controller 104 identifies if time information is entered in step 202. The time information refers to the information of the time previous to the time the afterimage is expected to happen, in case the same image continues to be displayed for a certain period of time. For example, on condition that the afterimage happens when the same image continues to be displayed for five minutes, the entered time information may be four minutes and fifty seconds.

If the controller 104 judges that the time information is entered in step 202, in step 203, it sets the time information as movement determination time. That is, the controller 104 sets a time that can determine whether the displayed image is moved based on the time information.

The controller 104 judges if the movement range information is entered in step 204. The movement range information includes the movement direction and the movement amount of the displayed image. The movement direction may be upper, lower, left and right direction, and the movement range may be one pixel. In addition to the one pixel, the movement amount information may be any values so long as the movement of the image cannot be recognized by the user. In step 205, the controller 104 sets the movement range of the image based on the information of the entered movement range.

The entry order of the above information about the conditions may change. That is, after the information on the movement range is processed, the time information can be processed.

In step 206, the controller 104 judges if the same image continues to be displayed for the movement determination time in the same way as the method of the comparator 103 of FIG. 1. If the controller 104 judges that the same image continues to be displayed for the movement determination time in step 206, it moves the image based on the information of the movement range in step 207.

The movement order and the movement method are performed as shown in the above description of the controller 104 of FIG. 1. That is, if the controller 104 judges first that the same image is maintained, it moves the image to the left by the pre-determined movement amount. Then, in step 208, the controller 104 judges if the afterimage elimination mode is OFF. If the afterimage elimination mode is not OFF, step 206 is performed.

If the controller 104 judges that the image is maintained for the pre-determined time in step 206, it moves the image to the upper direction by the pre-determined movement amount.

However, if the afterimage elimination mode is OFF in step 208, the task is completed. In addition, if the controller 104 judges that the same image is not maintained for the time in step 206, step 208 is performed.

Therefore, steps 206 through 208 are performed repeatedly if the same image is maintained for the pre-determined time with the afterimage elimination mode ON. Steps 206 and 208 are performed repeatedly if the same image is not maintained for the pre-determined time with the afterimage elimination mode on.

FIG. 2 shows that the present invention eliminates the afterimage depending on whether the afterimage elimination mode is ON or OFF. However, the present invention can eliminate the afterimage depending on whether the image position movement function is ON or OFF to eliminate the afterimage.

According to the present invention, even though the same image is displayed on the display panel for a certain period of time, the afterimage can be prevented.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An afterimage elimination apparatus comprising:
a display unit for displaying an input image signal; and
a controller for moving a display position of the image based on pre-determined movement range information if the controller judges that the image displayed on the display unit continues to be displayed for a certain period of time.

2. The apparatus of claim 1, wherein the movement range information is within values which prevent a user from visually perceiving the movement of the image.

3. The apparatus of claim 1, wherein the movement range information includes a movement direction and a movement amount.

4. The apparatus of claim 3, wherein the order of the movement directions is left, upper, right and lower directions, and the movement amount is set as one pixel.

5. An afterimage elimination apparatus comprising:
a memory for storing an input image signal;
a comparator for comparing frame image signals using data read from the memory and/or data written to the memory;
a display unit for displaying the image signal;
an operation unit for operating the display unit so that the image signal can be displayed on the display unit; and
a controller for controlling the operation unit so that the display position of the image can be moved based on pre-determined movement range information when the controller judges that the image displayed on the display unit continues to be displayed for a certain period of time after the comparison of the comparator.

6. A method for eliminating an afterimage from a display device, the afterimage elimination method comprising:
setting up a movement range of an image and a time to determine the movement of the image displayed on the display device if an afterimage elimination mode is set up; and
moving the image based on the information of the movement range if the image displayed on the display device continues to be displayed for a certain period of time.

7. The method of claim 6, wherein the movement range is set so that a user cannot visually perceive the movement of the image.

8. The method of claim 6, wherein the movement range is set in such a way that the image can be moved in left, upper, right and lower directions by a pre-determined movement amount at the pre-determined time interval.

9. The method of claim 6, wherein moving the image comprising:
a first movement step of moving the image in the left direction by a pre-determined number of pixels if it is judged that the image continues to be displayed for a certain period of time after frame image signals are compared;
a second movement step of moving the image in the upper direction by the pre-determined number of pixels if it is judged that the image continues to be displayed for the certain period of time after the first movement step;
a third movement step of moving the image in the right direction by the pre-determined number of pixels if it is judged that the image continues to be displayed for the certain period of time after the second movement step; and
a fourth movement step of moving the image in the lower direction by the pre-determined number of pixels if it is judged that the image continues to be displayed for the certain period of time after the third movement step.

10. The method of claim 9, wherein the first through the fourth steps are repeated until it is judged that the same image does not continue to be displayed for the certain period of time.

11. The method of claim 9, wherein the pre-determined number of pixels can be changed to another number of pixels to the extent that the user cannot visually perceive the movement of the image.
